(19) United States
(12) Patent Application Publication
(10) Pub. No.: US 2021/0394370 A1
(43) Pub. Date: Dec. 23, 2021

(54) INTELLIGENT ROBOTIC NURSING SYSTEM

(71) Applicant: Travelmate Robotics Inc., Las Vegas, NV (US)

(72) Inventors: Maximillian Kovtun, Las Vegas, NV (US); Leonid Kovtun, Las Vegas, NV (US); Taras Yermakov, Kiev (UA)

(73) Assignee: Travelmate Robotics Inc., Las Vegas, NV (US)

(21) Appl. No.: 17/354,726

(22) Filed: Jun. 22, 2021

Related U.S. Application Data
(60) Provisional application No. 63/042,304, filed on Jun. 22, 2020.

(51) Int. Cl. B25J 11/00; B25J 13/00

(52) U.S. Cl. CPC B25J 11/009; B25J 13/006

(57) ABSTRACT

An intelligent robotic nursing system includes a robotic medical platform vehicle that autonomously or manually moves within a structure to perform a healthcare task and information system containing data of symptomatic patients from all over the world to assist doctors in early detection of disease and providing effective treatments to patient.

### CROSS-REFERENCE TO RELATED APPLICATION

This application claims priority to U.S. Provisional Application No. 63/042,304, filed on Jun. 22, 2020, the complete disclosure of which, in its entirety, is herein incorporated by reference.

### TECHNICAL FIELD

The present invention relates to automated nursing care, and more particularly, to an intelligent robotic nursing system in conjunction with information system containing data of symptomatic patients from all over the world to assist doctors in early detection of disease and providing related effective treatments to patient.

### BACKGROUND OF THE INVENTION

Due to outbreak of Coronavirus pandemic, whole world is feeling saturated burden of illness that causes every human being and especially health staff members in a state of jeopardy by getting affected due to risk of infection. There is a need of some advanced automated system that can help the health care workers to communicate in time with Coronavirus patients efficiently and by maintaining proper distance with them. While treating these patients, health care workers should take extra care, so there should be some automated system that is capable enough to provide automated healthcare facilities like disinfecting patient rooms, emergency departments and operating rooms; decontaminating and sterilizing surgical instruments; preparing and dispensing medications; and transporting medical supplies like medications, meals and necessary medical devices. To avoid overcrowding of the places as it is the necessity of today's pandemic situation, there should be system which can move independently along the guided path to assist medical staff. Moreover, for dealing with this pandemic situation health workers have to provide full time services to the patient. So there should be need of improved system which can move both in indoor and outdoor environment for transportation of medical supplies to doctors as well as to patients. The system should be synchronized with any central information database facilitated by cloud service which is capable enough to store patient related data like medical record or medical history of patients, symptoms of confirmed Coronavirus patients from all over the world in order to provide doctors with information about treatment methods and their effectiveness, and to quickly determine the diagnosis.

One of the closest prior art U.S. patent application Ser. No. 16/391,921 discloses apparatuses, systems, and methods for improving the efficiency of medication distribution within a healthcare facility. In particular, embodiments may provide for dispensing medications needed and medications anticipated to be needed to an authorized medical person for administration to a patient in a healthcare facility. Methods may include receiving an indication of one or more unit dose medications anticipated to be needed by a patient; retrieving the one or more unit dose medications from a unit storage device; loading the one or more unit dose medications onto a transport device; transporting the one or more unit dose medications from the unit storage device to a location proximate the patient; and transferring the one or more unit dose medications from the transport device to a staging area at the location proximate the patient.

The Chinese Patent Application CN105260588B discloses a kind of health of the present invention guards robot system and its data processing method, is related to medical field, more particularly to a kind of health data for integrating fragmentation, to realize science user health behavior intervention a kind of intelligent health guardian system. Its purpose is to provide it is a kind of it is simple in structure, at low cost, easy to operate, integrate the health data of fragmentation, intellectual analysis and by a kind of healthy guardian system of system intervention user health behavior. It includes acquisition module that a kind of health of the present invention, which guards robot system, is used to acquire health, the medical data of user Health of the server by upload, medical data are compared, analyze and model calculation, generate health data summarize, assessment report and Health intervention scheme, and provide control and support to the operation of virtual robot Terminating machine is used to log in registration user, and registration user is received to the health data of acquisition module, the display module equipped with display health data, system function.

The aforementioned prior arts addresses the problems associated with the transportation of medications, problems associated with monitoring and tracking patient record and evaluation on the basis of the patient related data and addresses the solution for the same. But none of the prior arts addresses the problems of tracking, collecting and processing medical parameters and symptoms collected from around the world in order to provide doctors with information about treatment methods and their effectiveness and to quickly determine early diagnosis of disease.

Hence there is a need for an improved automated guided system which can provide assistance to the doctors by providing information about treatment methods and their effectiveness and can quickly detect the disease on the basis of patient medial data.

### SUMMARY OF THE INVENTION

The present invention addresses the deficiencies of known automated nursing system by providing a robot device in conjunction with information system of health signs of patients that can assist doctors in applying efficient treatment and medications on the basis of patient health signs without coming in contact with patients.

One of the preferred embodiments of the present invention is to provide an robotic medical platform (RMP) which is capable of reading and processing the data received from the plurality of electronic user devices which may include but not limited to mobile devices, smart health bracelet or tracker in order to transfer the processed data to the information system of symptoms and health signs of patients and display the processed data on the users interface of multiple electronic devices which may include smart phone, tablet etc. The information system maintains a database on the central server or a cloud computing system which is accessible to authorized person like doctor or any authorized medical staff from where they can get each and every detail related to patient and can provide effective treatments to them on the basis of their health track record.

Another embodiment of the present invention is to provide a robotic medical platform (RMP) that is guided to move independently along the guided paths manually or autonomously in different indoor and outdoor places and is proficient enough to avoid obstacles in the form of objects or individuals.

Another embodiment of the present invention is to provide a RMP to receive and read patient related data from plurality of electronic devices. The data may include symptoms of positive patient with Coronavirus disease, medical history of patient, vital signs like pulse rate, heart rate etc. and optimal available treatment etc.

Another embodiment of the present invention is to provide an RMP which is capable of controlling installed equipment like camera, arm of robot and other equipment like oxygen concentrator, hospital bed etc. The robots and equipment are installed with controller unit configured with transmitters and receivers of receiving signals from multiple electronic devices.

Yet another embodiment of the present invention is to provide an RMP that can help the healthcare workers in the transportation of medical supplies. The transportation of medical supplies may include transportation of medical equipment like stethoscopes of doctors, or sterilization fluids, dose unit of medications as suggested by the doctors etc.

Yet another embodiment of the present invention is to alert the authorized healthcare workers like nurses or doctors if the health equipment shows abnormal signals or shows values beyond the boundary values. For example, Blood Pressure (BP) monitor shows value of BP of patient beyond the prescribed value.

yet another embodiment of the present invention is to provide an information system comprising a processor and a memory configured to store the instructions executed by the processor. The processor is configured to read and process the data received form the plurality^{,} of electronic user devices in order to transfer the processed data to a plurality of servers; display the processed data on the plurality of the electronic devices and provide effective treatments to the patients on the basis of their health track record.

### DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In order to achieve the aforementioned objects, an intelligent robotic medical platform (RMP) with information system is presented. An intelligent robot system is presented that includes a robotic medical platform (RMP) that moves autonomously and manually within the indoor structure or outdoor structure to perform healthcare chores. The RMP further comprises multi navigational unit, an on-board computer, power source, a wireless communication system for receiving and sending signals, server.

The robot platform comprises robotic vehicle adopted for the operation in different indoor and outdoor conditions (wheel based including standard and omni wheels for the good maneuverability, but not limited to) based on multi-level navigation system that can travel manually or autonomously in various dynamic and static environments. The multi navigational unit helps the robotic medical platform (RMP) in travelling manually or autonomously in various dynamic and static environments. It includes sensors, controller, transmitter, receivers, motor controller, motor and wheels, Bluetooth modules, GPS module, GSM module, Wi-Fi module, user interface etc.

Sensors may be multiple in numbers and may be any type of sensor that is suitable for functioning of RMP. It may be mounted in a fixed position or alternatively in a such a position so that it is able to change its position and orientation according to the navigator. Sensors may^{,} include but not limited to camera vision system, radar, LIDAR, sonar and/or combinations thereof. The camera vision system may include one camera or a plurality of cameras to provide stereo vision for obtaining more detailed and accurate information about the robot's environment. The sensors helps the RMP in avoiding obstacles, viewing, mapping, markings so that the RMP can move autonomously along the guided path. A controller comprises processors or central processing unit (CPU), a temporary storage or RAM, and a non-volatile storage. Information such as maps and task schedules are stored in non-volatile storage which, in one implementation, is an EPROM or EEPROM. Controller receives and processes information from sensor regarding the RMP surrounding environment. This may include information such as the location of navigator, the location of the other objects, nearby landmarks and so on. Controller sends appropriate commands to motor controller. Motor controller directs motor in accordance with these commands of the controller. Motor drives wheels in accordance with the commands of the motor controller. The wheels may include but not limited to standard and Omni directional wheels for good locomotion of robotic medical platform. In this way multi navigational unit controls the maneuvering of robotic medical platform. Further controller also controls the functions of RMP via transmitter. Controller processes sensor information received by sensor to determine the task, movement or other function, the RMP should undertake next. Transmitter transmits appropriate control signals to receiver of RMP. Transmitter and receiver may use any wireless communication system include, but are not limited to, wireless communication, infrared signals and magnetic induction. Wireless Communication may comprise blue tooth module, GSM module, WIFI module etc. used for sending and receiving signals by RMP. Controller of RMP sends the processed data from the sensors to the user interface so that the user can easily see the information and change the settings, parameters or data accordingly. The user interface may include but not limited to touch screen monitor, mobile phones, tablet, laptop. The monitor can easily be removed providing flexibility to the users. The authorized users can change the settings or any data related to patient through the user interface provided in the system.

The power source of RMP comprises any suitable power source including, but not limited to, batteries, electrical outlets, fuel cells, internal combustion or other engines, or combinations thereof. The power source charges the plurality of medical equipment to provide power supply to RMP.

The robotic medical platform has a computer on board with preinstalled software for the data processing that provides prompt patient's identification, initial guidance and instructions for medications, testing and medical history of a patient. It further helps in guiding authorized users or medical staff like doctors in the treatment of patients and in providing instructions for medications. The on-board computer of RMP may communicate through wireless communication system, to plurality of electronic devices for identification of patient, tracking the health indicators of the patient, sending the test results to a server or any cloud computing system in order to synchronize with medical history data base in the information system of symptoms and health (medical) indicators of patients. The RMP can constantly perform and record the test results and in an emergency to telephone a healthcare provider.

The data stored at said information system is constantly updated and allows authorized users like doctors to access the patient data to select best treatment procedure. If the doctors have changed any prescription, changes in chart of patient, any change related to medication dose, in accordance with the patient condition, the RMP sends signals or issue alerts on any change set by authorized doctor to other authorized users.

There are plurality of client devices accessible by authorized user and multiple servers through which the clients can achieve the functionally of RMP. Every server is identified by their own unique address and every client has its own unique ID. When a client device or authorized user or RMP sends any patient data to a server, server identifies that whether this data packet is for that server or other only by the way of their address. This reduces hardware dependency, to improve usability and to provide a server-client communication framework.

For the achievement of client server framework, the present invention is disclosing the aspects of robotic medical platform (RMP) but other options like web interface and mobile application which may include both android and ios application. For achieving invention, the Logical database schema includes but not limited to table with these normal indicators for different groups of patients, tables with tolerances, tables with patient indicators, rules for comparing and issuing messages when comparing indicators, list of authorized users etc. The hardware and software platform architecture includes the remote based RMP clients which collects and sends data to server and the server part analyzes the data and stores it in the database facilitated by cloud service. The web interface (or any remote application: android, iOS) authorizes the user, requests data from the server and displays it on the screen.

The best mode of carrying the operation of present invention is disclosed. The method includes access authorization by authorized user to information system of patient data, receiving the patient data through plurality of user devices, sensors, transmitters, storing the patient data into the hospital database at information system, displaying data through the user interface on the user devices or RMP monitor, filtering the data according to the predetermined parameters, plotting the graphs according to the filtered data and comparing the graphs with the graphs of predetermined data, generates assessment reports on the basis of plotted graphs of patient data, recommendation of tests, prescriptions, medications, treatments, food etc. on the basis of the medical history of patients.

It is to be understood, however, that even though numerous characteristics and advantages of the present invention have been set forth in the foregoing description, together with details of the structure and function of the invention, the disclosure is illustrative only. Changes may be made in the details, especially in matters of size, and arrangement of parts within the principles of the invention to the full extent indicated by the broad general meaning of the terms mentioned.

What is claimed is:

1) An intelligent robotic nursing system, said system comprising:
a robotic medical platform; and
an information system;
wherein the robotic medical platform is in conjunction with the information system, assists authorized healthcare workers in early diagnosis of disease for providing effective treatment to patients.

2) The system as claimed in claim 1, wherein the robotic medical platform comprises:
a multi-navigational unit, configured to assist the robotic medical platform, to move independently along the guided paths manually or autonomously in different indoor and outdoor places;
an on-board computer, configured to assist the robotic medical platform in early diagnosis of disease and providing effective treatment to patients;
a power source, configured to provide power to the robotic medical platform and onboard medical equipment;
a wireless communication system, configured to connect a plurality of electronic devices to the robotic medical platform, to receive and send data of patients; and
a server, configured to manage patient data received through plurality of electronic devices and send to said information system for effective treatment of patient.

3. The system as claimed in claim 2, wherein said automated guided vehicle configured to detect objects or individuals in its path to avoid obstacle.

4. The system as claimed in claim 3, wherein the patient data comprises data symptoms of positive patient with corona virus disease, medical history of patient, vital signs and optimal available treatment.

5. The system as claimed in claim 1, wherein the robotic medical platform is capable of controlling a plurality of equipment.

6. The system as claimed in claim 5, wherein the on-board equipment includes camera, hospital equipment or user devices.

7. The system as claimed in claim 1, wherein the robotic medical platform is capable of transporting of medical supplies.

8. The system as claimed in claim 1, wherein the robotic medical platform is capable of monitoring medical equipment and producing alert to the authorized healthcare workers if the health equipment shows values beyond the boundary values.

9. The information system as claimed in claim 1 comprising:
a processor; and
a memory configured to store the instructions executed by the processor, wherein the processor is configured to:
read and process the data received from a plurality of electronic user devices in order to transfer the processed data to a plurality of servers;
display the processed data on the plurality of electronic devices; and
provide effective treatments to the patients on the basis of their health track record.
